(19) United States
(12) Patent Application Publication
(10) Pub. No.: US 2016/0347385 A1
(43) Pub. Date: Dec. 1, 2016

(54) CONTROL SYSTEM FOR BALANCE CONTROL OF INTELLIGENT DEVICE

(71) Applicant: HON HAI PRECISION INDUSTRY CO., LTD., New Taipei (TW)

(72) Inventor: CHIEN-LIH LUNG, New Taipei (TW)

(21) Appl. No.: 15/080,701

(22) Filed: Mar. 25, 2016

(30) Foreign Application Priority Data
May 29, 2015 (CN) 201510285186.4

(51) Int. Cl. B62D 57/032

(52) U.S. Cl. CPC B62D 57/032; Y10S 901/01

(57) ABSTRACT

A control system for balance control of an intelligent device, the control system includes a detector, a processor, and a control device. The detector is configured to detect movement of a center of gravity of the intelligent device, the processor is configured to output a control signal for the movement of the center of gravity of the intelligent device satisfying a first range, the control device is configured to adjust a motion of the center of gravity of the intelligent device by the control signal.

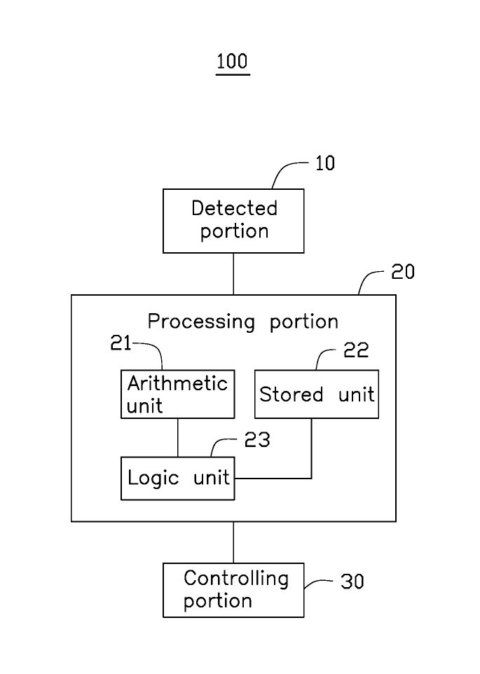

### FIELD

The subject matter herein generally relates to a control system for balance control of an intelligent device.

### BACKGROUND

A biped robot can automatically move using artificial intelligence technology currently exist. The biped robots can help to do tedious and redundant work like manufacturing or assembly. When the biped robots move, the biped robots may well have a chance to fall down for experiencing an external force, like impact, or strong wind. Since the biped robots are heavy, they tend to be damaged or they tend to cause damage to an object that is hit by the robots when the biped robots fall down.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure.

Implementations of the present technology will now be described, by way of example only, with reference to the attached FIGURE.

The FIGURE is a block diagram illustrating an embodiment of a control system for balance control of an intelligent device

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

The present disclosure relates to a control system for balance control of an intelligent device.

The FIGURE illustrates a control system 100 including a detector 10, a processor 20, and a control device 30. In the illustrated embodiment, the control system 100 is positioned in an intelligent device. In the illustrated embodiment, the intelligent device is an intelligent robot, and the control system 100 is configured to adjust balance of the robot.

The detector 10 is configured to detect if a state of the robot is changed by an external force. The state includes a angular deviation of the center of gravity of the robot or movement of a center of gravity of the robot. In the illustrated embodiment, the detector 10 receives the movement of the center of gravity of the robot by detecting a displacement of the center of gravity in an inertial coordinate system and outputs a movement signal of the center of gravity of the robot to the processor 20. In addition, the detector 10 is positioned at the center of gravity of the robot so as to precisely detect the movement of the center of gravity of the robot in real time. The detector 10 can be one or more of a gyroscope, an accelerometer, or an infrared sensor. In other embodiments, the detector 10 is positioned on a surface of the robot.

The processor 20 is coupled to the detector 10. In the illustrated embodiment, the processor 20 is electrically connected with the detector 10. The processor 20 is configured to receive the movement signal of the center of gravity of the robot and outputs a control signal into the control device 30. The processor 20 includes a calculating unit 21, a storage unit 22, and a logic unit 23.

The calculating unit 21 is coupled to the detector 10. In the illustrated embodiment, the calculating unit 21 is electrically connected with the detector 10. The calculating unit 21 receives the movement signal from the detector 10 and calculates a first angular deviation for the movement of the center of gravity of the robot.

The storage unit 22 is configured to store a safe range and a balanced range, the safe range is defined for a second angular deviation of safe movement of the center of gravity, the balanced range is defined for a third angular deviation of balanced movement of the center of gravity. The safe range is smaller than the balanced range.

The logic unit 23 is coupled to the calculating unit 21 and the storage unit 22 and is configured to compare the first angular deviation with the safe range and the balanced range. In the illustrated embodiment, the logic unit 23 is electrically connected with the calculating unit 21 and the storage unit 22. The logic unit 23 receives the first angular deviation from the calculating unit 21 and compares the first angular deviation with the safe range receiving from the storage unit 22. When the first angular deviation is larger than the safe range, the logic unit 23 receives the balanced range from the storage unit 22 and compares the first angular deviation with the balanced range. When the first angular deviation is larger than the balanced range, the robot falls over. On the other hand, the first angular deviation is less than the balanced range and satisfies a first range; the first range is defined between the safe range and the balanced range, the processor 20 outputs the control signal to the control device 30.

The control device 30 is coupled to the processor 20. In the illustrated embodiment, the control device 30 is electrically connected with the processor 20. The control device 30 receives the control signal from the processor 20 and adjusts a motion of the center of gravity of the robot by the control signal for a balance of the robot. In at least one embodiment, the center of gravity of the robot is moved by the control device 30 toward a ground by changing postures. The posture of the robot is selected from kneeling, squatting, or sitting. In other embodiments, the center of gravity of the robot is moved by the control device 30 toward a direction away from the movement of the center of gravity of the robot. In other embodiments, the robot includes a first device, the first device is a heaviest device in the robot and may be a power device; the control device 30 moves the first device downward to change the center of gravity of the robot.

When the robot experiences the external force like impact, or strong wind, the detector 10 detects the state of the robot has changed by the external force. In the illustrated embodiment, the detector 10 detects the movement of the center of gravity of the robot and outputs the movement signal of the center of gravity of the robot to the calculating unit 21 of the processor 20. The calculating unit 21 calculates the first angular deviation for the movement signal. The storage unit 22 of the processor 20 stored the safe range and the balanced range.

The logic unit 23 receives the first angular deviation from the calculating unit 21 and compares the first angular deviation with the safe range and the balanced range receiving from the storage unit 22. When the first angular deviation satisfies the first range between the safe range and the balanced range, the processor 20 outputs the control signal to the control device 30. The control device 30 adjusts the motion of the center of gravity of the robot by the control signal for the balance of the robot. In at least one embodiment, The control device 30 adjusts the motion of the first device to for the balance of the robot, and the first device is a heaviest device in the robot like a power device.

The embodiments shown and described above are only examples. Many details are often found in the art such as the other features of a control system for balance control of an intelligent device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A control system configured to adjust a balance of a robot, the control system comprising:
at least one processor;
a detector coupled to the at least one processor and configured to detect movement of a center of gravity of the robot;
a control device coupled to the processor and configured to adjust movement of the center of gravity of the robot;
whereby the at least one processor is configured to receive a movement signal from the detector and output a control signal to the control device, the control device adjusts a motion of the center of gravity of the robot by the control signal.

2. The control system in accordance with claim 1, wherein the first range is defined between a safe range and a balanced range, the safe range is defined for a second angular deviation of safe movement of the center of gravity, the balanced range is defined for a third angular deviation of balanced movement of the center of gravity, the safe range and the balanced range are stored into the robot.

3. The control system in accordance with claim 2, wherein the processor includes a calculating unit, a storage unit, and a logic unit, the calculating unit is configured to calculate a first angular deviation of the movement of the center of gravity of the robot from the movement of the center of gravity of the robot, the storage unit is configured to store the safe range and the balanced range, the logic unit is configured to compare the first angular deviation with the safe range and the balanced range.

4. The control system in accordance with claim 1, wherein the detector is positioned in the robot.

5. The control system in accordance with claim 1, wherein the detector is positioned at a position of the center of gravity of the robot.

6. The control system in accordance with claim 1, wherein the detector is positioned on a surface of the robot.

7. The control system in accordance with claim 1, wherein the center of gravity of the robot is moved by the control device toward a direction away from the movement of the center of gravity of the robot.

8. The control system in accordance with claim 1, wherein the center of gravity of the robot is moved by the control device toward a ground with changing a posture of the robot.

9. The control system in accordance with claim 1, wherein the control device moves a first device toward a ground for changing the center of gravity of the robot, the first device is a heaviest portion in the robot.
